(19) United States
(12) Patent Application Publication
(10) Pub. No.: US 2003/0061315 A1
(43) Pub. Date: Mar. 27, 2003

(54) System and method for "Plug and Play" ability to broadband network based customer devices

(76) Inventor: Frank Kui Jin, Sammamish, WA (US)

Correspondence Address: FRANK K. JIN, 20041 SE 24th St., Sammamish, WA, 98075, US

(21) Appl. No.: 10/244,116

(22) Filed: Sep. 16, 2002

Related U.S. Application Data
(60) Provisional application No. 60/324,503, filed on Sep. 25, 2001.

(51) Int. Cl. G06F 15/177; G06F 15/16

(52) U.S. Cl. 709/220; 709/203

(57) ABSTRACT

A distributed broadband network comprises of unconfigured broadband-based customer devices or network computers and at least one auto configuration and monitoring server. A network protocol called Plug and Play Host Protocol (PPHP) is defined to facilitate the automatic connections between an auto configuration server and a number of unconfigured broadband customer devices or network computers. The customer device determines on power on time if it has been identified and configured through the auto configuration server. If the identification and configuration information are lacking, the customer device sends an identification and configuration request to the auto configuration server using a multicast message with a predefined multicast group. Upon receiving the identification request from a new customer device, the auto configuration server chooses a unique computer name for the customer device and sends the computer name along with some other initialization information to the customer device using another multicast message with another predefined multicast group. The customer device uses the unique computer name and other configuration information received to configure itself and establish connections to the service providers in the network. After the initial discovery and configuration phase, the connection channels established between an auto configuration server and a plurality of managed customer devices are used continuously for automatic monitoring and remote management of the customer devices.

### CROSS REFERENCE TO RELATED APPLICATIONS

This application is related to U.S. provisional patent application No. 60/324,503 still pending, entitled “System and method for ‘Plug and Play’ ability to broadband network based customer devices”, filed on Sept. 25, 2001, which is hereby incorporated by reference.

### BACKGROUND OF THE INVENTION

A TCP/IP based broadband customer device, such as a high end settop box, is actually a high performance network computer. These broadband customer devices typically roll off a production line with the same operation image. That means that all of the customer devices have the exact same network identity and a default configuration when they leave the production line. They have to undergo some sort of configuration procedure before they can be used in a specific intranet environment by end users. The most important step in this configuration procedure is to set a proper network identity for each of the customer devices in an intranet based on a predefined scheme. There are usually some other configuration steps in the configuration procedure, such as setting up IP addresses for different network servers in the customer devices. Because these customer devices are usually deployed with a large quantity in a customer environment, it is desirable that the configuration procedure can be performed automatically without any user intervention.

The configuration methods currently used can be classified as either (a) sending a trained technician to customer sites to do the manual configuration for each customer device or each network computer; (b) shipping a detailed configuration manual with each broadband-based customer device and asking the end user to perform the configuration by reading the User's Manual. Neither of the methods is suitable for a large-scale deployment of the broadband-based customer devices because of the need of the manual configuration on the client side.

After the initial network configuration to all of the managed customer devices, how to monitor and manage them remotely on the daily basis is another major concern to the service providers. Therefore, a platform that provides the mechanism for remote and automatic management of broadband customer devices in a point-to-points mode without using any significant bandwidth is much needed for IT personnel to manage a large number of the broadband based customer devices efficiently.

The system and method presented in this invention provide a complete solution to both of the automatic initial configuration and daily remote management to the broadband-based customer devices.

### BRIEF SUMMARY OF THE INVENTION

The present invention overcomes the shortcoming of the above-mentioned methods by providing a completely automated system and method for configuring and monitoring broadband-based customer devices. With this invention, the configuration process on the client side is as simple as plugging in the broadband connection and turning on the power for each customer device. Thus, the configuration of the broadband-based customer device is completely transparent to the end user. Furthermore, the invention provides the ability to automatically monitor and remotely manage broadband-based customer devices from a centralized auto configuration server.

In summary, the present invention is a system and method for the automatic configuration and remote management of broadband-based customer devices from a centralized auto configuration server. The auto configuration server has a client information database (CIDB) that contains all of the configuration information for each managed customer device. The core of the invention is a client-server communication protocol between the auto configuration server and the managed customer devices, which is called as Plug and Play Host Protocol (PPHP), as summarized below. The communication mechanism established by using PPHP between the auto configuration server and managed customer devices can be used to perform automatic monitoring and remote management of the managed customer devices from the centralized auto configuration server.

The PPHP specifies shared multicast groups and communication sequences between a PPHP server (part of the auto configuration server) and multiple PPHP clients (broadband-based customer devices). A PPHP server should be configured and up running before any PPHP clients can be connected to the network. The PPHP server must join SIGNON_SVR, a predefined multi-cast group, to wait for the connection requests from any PPHP clients. In addition, the server needs to setup a unicast port called SVR_ACK_PORT to listen acknowledgements and some potential errors from clients.

When a new PPHP client first appears on the network, it joins INIT_GROUP, another predefined multi-cast group, and sends out a configuration request, SIGNON, with its identification information to the PPHP server using a multicast message to SINGON_SVR. Upon receiving the SIGNON message from a new client, the server builds up an initialization message using the information from CIDB and the client's request. Then it sends out the initialization message, INIT, to INIT_GROUP as a multicast message because at this point the client who supposes to get the message may have not been configured with a proper IP address. Because of the hardware identification contained in the initialization message, the targeted client will be the only one to process the INIT message. The client must send the configuration request repeatedly until it receives its initialization message. After processing the initialization message, the client must send an INIT_DONE message to SVR_ACK_PROT. Then the client needs to join GEN-CONFIG_GROUP, a predefined multicast group for a common configuration update, and listen on SPE_CFG_PROT, a predefined unicast port for any specific configuration update.

The invention completely eliminates the need to do any manual configuration on the client side for broadband-based customer devices or any network computers that support TCP/IP multicasting. The administrator uses the auto configuration server to configure all of the managed PPHP clients. After the initial configuration, the PPHP clients-server infrastructure is used for daily system updates and performance monitoring of the broadband-based customer devices.

### BRIEF DESCRIPTION OF THE DRAWINGS

FIG. 1 is a typical network topological structure wherein there are an auto configuration server (ACS), a number of auto configuration clients (ACC) located in different subnets or segments and two subnet relay agents (SRA).

FIG. 2 illustrates the PPHP messages among an ACS, a SRA and a number of ACCs. As described in the diagram, a SRA is responsible to relay all of the PPHP multicast messages from the ACCs within the same subnet or segment to a connected ACS. All of the PPHP unicast messages are communicated directly between an ACS and ACC(s).

FIG. 3 is a system block diagram for the invention. It gives more details about the components in an ACS.

### DETAILED DESCRIPTION OF THE INVENTION

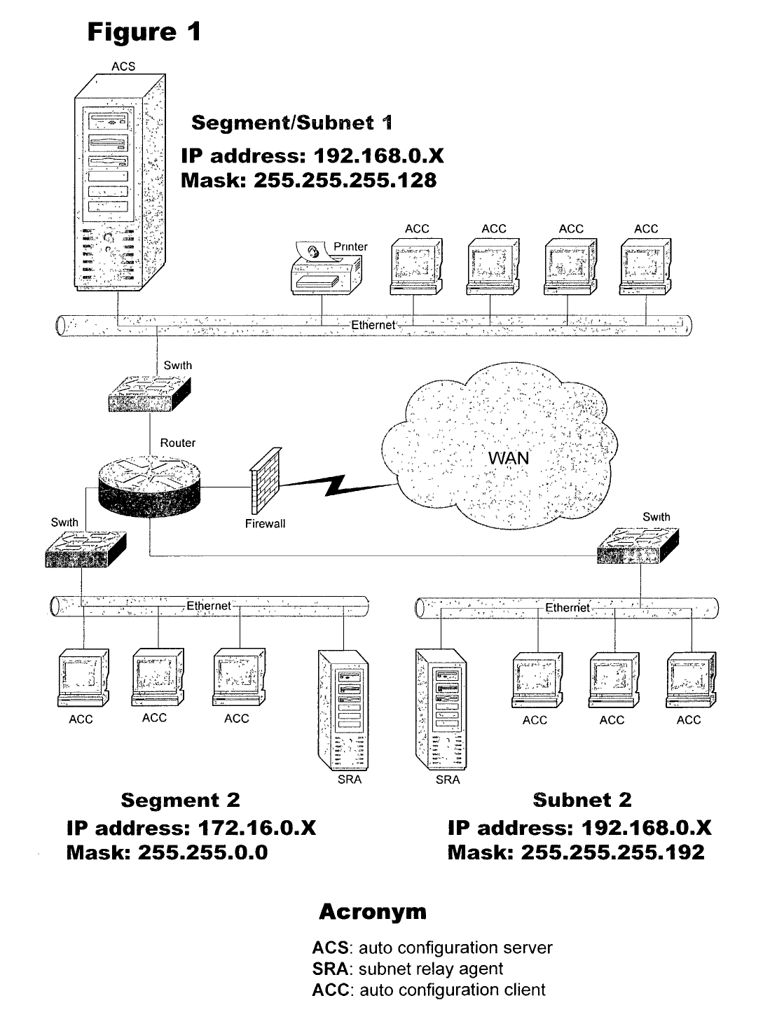

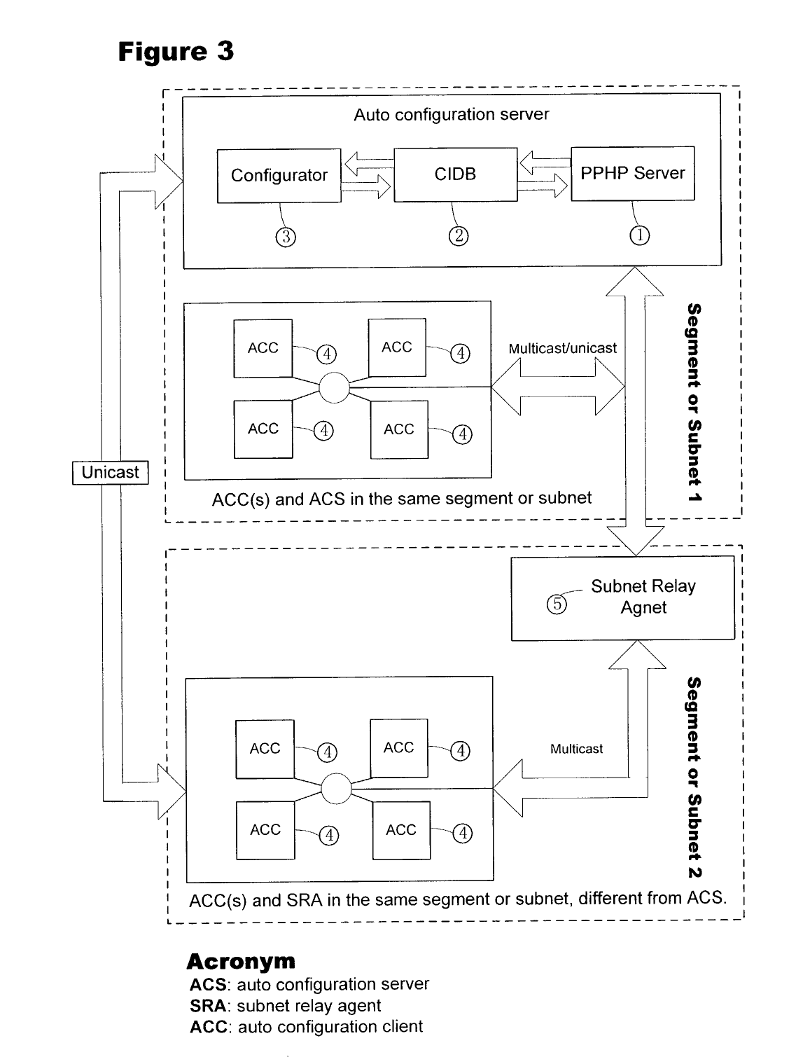

This invention creates a network system structure, as illustrated in FIG. 1, which comprises five major subsystems: a Configurator, a PPHP Server, a Client Information Database (CIDB), and a plurality of PPHP Clients and a plurality of PPHP Relay Agents. As displayed in FIG. 3, an Auto Configuration Server (ACS) is comprised of a Configurator, a PPHP Server and a CIDB. A PPHP Client can also be called as an Auto Configuration Client (ACC). A PPHP Relay Agent is also called as a Subnet Relay Agent (SRA). The five subsystems are related together by Plug and Play Host Protocol (PPHP) as described below.

The core idea for PPHP is to provide a reliable mechanism using multicast communications to let network computers automatically get their network configuration information from a centralized server even before the network computers are properly configured. The only assumption PPHP made is that the network supports TCP/IP multicasting.

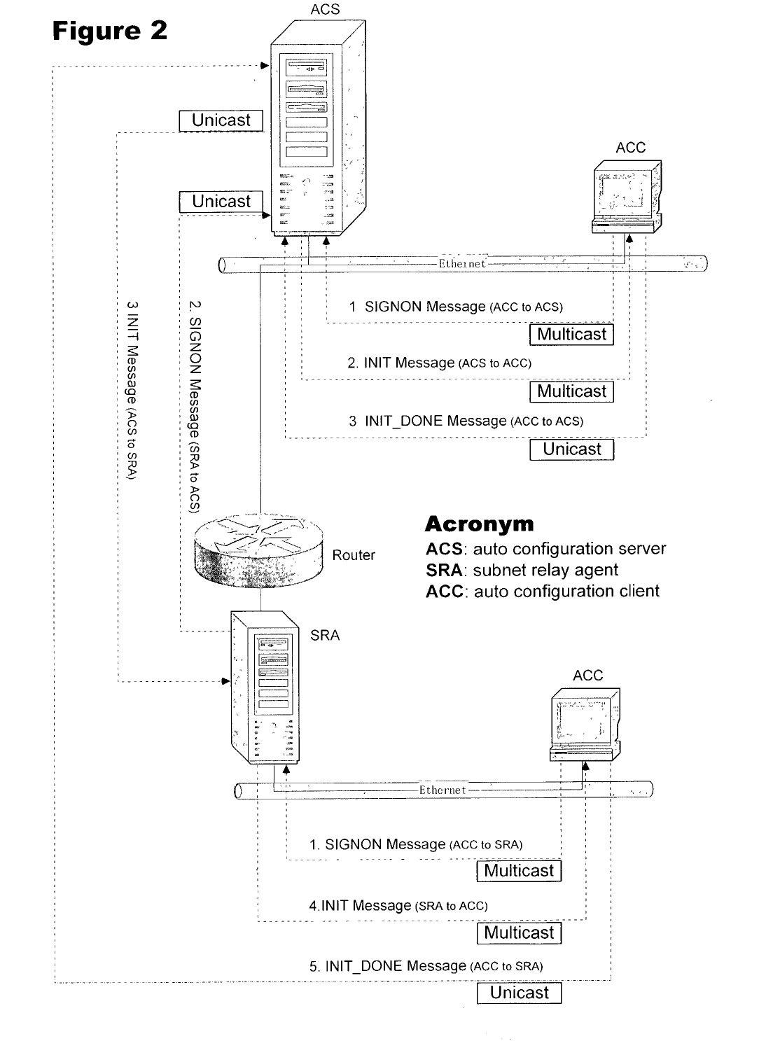

PPHP specifies a series of messages used to establish the connections and facilitate the communications between a PPHP Server and a number of PPHP Clients, as described in FIG. 2.

1. SIGNON Message: This is a multi-cast message that is used by a new client to connect to a PPHP Server through a predefined multi-cast group. The message contains: message ID that is SIGNON, MAC address of the computer, and etc.

2. INIT Message: This is also a multicast message that is used by the PPHP Server to send the initialization data to a specific new client. The message contains: message ID that is INIT, MAC address of the targeted client machine, computer name that is assigned to the client machine, the PPHP Server's IP address/host name and the server's unicast listening port, and etc.

3. INIT_DONE Message: This is a unicast message from a client to the server's listening port to notify the server that the client has successfully processed the INIT message. The message contains: message ID that is INIT_DONE, the client's computer name, and etc.

4. GEN_CONFIG Message: This is a multi-cast message that is used for the server to send general configuration updates to a number of clients. The message contains: message ID that is GEN_CONFIG, a serial number to identify this GEN_CONFIG message, hostname mask that define the group to receive the message, a list of configuration data and etc.

5. GEN_CFG_ACK Message: This is a unicast message from a client to the server to acknowledge the receiving of a specific GEN_CONFIG message. The message contains: message ID that is GEN_CFG_ACK, the serial number and the hostname and etc.

6. SPE_CONFIG Message: This is a unicast message from the server to a specific client to update the client's configuration. The message contains: message ID that is SPE_CONFIG, a serial number, a list of configuration data and etc.

7. CLIENT_ERR Message: This is a unicast message for a client to report some error conditions to the server. The message contains: message ID that is CLIENT_ERR, hostname, the message ID that the error is related to, error message and etc.

8. STILL_ALIVE Message: This is a unicast message sent from a client to server's SVR_ACK_PORT periodically. The message contains: message ID that is STILL_ALIVE, hostname and etc.

PPHP defines following multicast groups and socket ports:

1. SIGNON_SVR: This multicast group is used to facilitate the initial connections between a server and a number of clients before the network configurations of the clients are properly done. The PPHP Server is the only one to join the group and listen to SIGNON requests from a number of clients. A new PPHP client needs to send a multicast message, SIGNON, to this group.

2. INIT_GROUP: this is a multicast group that all of the clients will join in initially to receive the initial INIT packages from the server. A PPHP server uses this group to send out the multicast message, INIT, to new PPHP clients.

3. GEN_CONFIG_GROUP: this multicast group is used to implement the configuration updates for the whole group or part of the group. All of PPHP clients join in this group and a PPHP server sends out multicast message, GEN_CONFIG, to this group.

4. SVR_ACK_PORT: this is the server port to listen the acknowledgements or some potential errors from clients.

5. SPE_CFG_PORT: this is the client port to receive customized configuration messages from the server.

To establish an initial connection between a PPHP server and PPHP clients, and configure the clients as specified, the following sequence of messages will be sent between the server and clients.

1. PPHP clients join INIT_GROUP multicast group to listen to INIT messages. Then, in order to look for a PPHP server, every PPHP client will send out SIGNON request to multicast group, SIGNON_SVR, repeatedly until it receives the INIT message specific for itself.

2. After the server receives a SIGNON message, it builds up an INIT message using the information from CIDB and the SIGNON message. Then it sends out the INIT message to INIT_GROUP.

3. All of the clients in INIT_GROUP will receive every INIT message the server send out. But only the client found a matching MAC address processes the message.

4. After processing INIT message, the client must send out an INIT_DONE message to SVR_ACK_PORT. At this time, the client needs to create two listening sockets: one is to join GEN_CONFIG_GROUP; the second is on SPE_CFG_PORT.

PPHP requires that the computer name for each client computer must be unique. When DHCP is used to assign an IP address to a client computer, the computer name is the only unique ID for the client. When a static P is used for a client computer, PPHP still uses the unique computer name to identify the client. This gives the system the ability to switch the IP address type back and forth between DHCP and static IP for a client computer. PPHP provides three schemes to assign a unique computer name to a new client computer (or a new customer device) as described below.

Scheme One: A pool of unique computer names is predefined and stored in a CIDB on the server side. For each new connected client, the server will pick up a unique name sequentially from the pool and assign the name to the new client automatically. This is the simplest way to assign a unique computer name to a client computer. The only way to associate a client computer to a specific name in this scheme is to control the sequence of the connection to the server for each client. For example, if you want a client computer to get the third name in the pool, you need to make sure that the client is the third computer to connect to the server, and so on.

Scheme Two: A root name is predefined on the server side. For each new connected client, a popup window comes out on the client computer to let an end user to enter a client feature ID, such as a room number in a hotel. Then the system will automatically build up a full computer name using the root name from the server and the client feature ID, and assign the name to the client computer.

Scheme Three: A pool of unique computer names is predefined on the server side. For each new connected client, the server requires the client to provide a computer name that matches one of the names in the pool. If the existing name in the client computer does not match any name in the pool, a popup window comes out on the client computer to let an end user to enter a matching name, and then assign the matched name to the client computer.

The Configurator, as described in FIG. 3, is a utility subsystem to allow network administrators to specify the configurations to each managed client computers. In order to save user's time to survey current client information, the Configurator searches all connected clients using multicast communications even before they are properly configured. Therefore a user does not have to type in all of the computer names for each managed client computers if they don't want to change them. The client network configurations that can be specified with the Configurator include computer name, IP address, static IP or DHCP, DNS, WINS, Gateway IP and etc. After specifying the network configurations for each managed client, the information will be saved in CIDB to share between the Configurator and a PPHP Server.

The PPHP Server, as described in FIG. 3, is the subsystem that monitors and manages all of PPHP clients at real time. It acquires the information about all of the managed clients from CIDB and also writes all of updated information about the managed clients back to CIDB. For each new client, the server is responsible to listen to the SIGNON request, and build up and send out the INIT message. Then it also updates the connection status on the server UI and in CIDB. After the connection phase, the server will manage the STILL_ALIVE messages periodically sent from each connected client to update the client connection status. At runtime, the connection channels between the server and managed clients are used to remotely update the configurations, manage the client systems and distribute files, and etc.

The Client Information Database (CIDB), as described in FIG. 3, is a central depositary for all of client related information. A synchronization mechanism has been implemented in CIDB because it is a shared database between Configurator and PPHP Server. CIDB is a real time database. The information and status for each online client can change at any time and the record for each client in CIDB must be updated accordingly.

The PPHP Client or ACC as described in FIG. 3 runs in each managed customer device or client computer. It is responsible to send out SIGNON request repeatedly until it receives the INIT message expected. After processing the INIT message, it will send out INIT_DONE message to the server. Then it sends out STILL_ALIVE messages periodically to maintain the connection with the server. While connected, it listens to messages from the server on GEN_CONFIG_GROUP and SPE_CFG_PORT, and processes the messages to update the client system or perform some required tasks.

The PPHP Relay Agent or SRA as described in FIG. 3 is a subsystem to expand the applied scope of PPHP into the network where more than one subnets or segments exist. As described above, the core idea for PPHP is to automatically configure network computers from a centralized server using multicasting. However, multicasting messages usually cannot travel across different subnets or segments. To make PPHP work for multiple subnets or segments, the PPHP Relay Agents are used to relay the PPHP multicasting messages between a PPHP Server and PPHP Clients located in different subnets or segments. The communications between a PPHP Server and a PPHP Relay Agent are point-to-point TCP communication. The communications between a PPHP Relay Agent and the PPHP clients within the same subnet or segment are multicasting communication.

As described in FIG. 2, for a network with multiple subnets or segments, PPHP will work as following:

1. All of the PPHP clients join a predefined multicasting group, INIT_GROUP, to receive INIT messages from a PPHP server.

2. A PPHP client sends out SIGNON messages repeatedly to the predefined multicasting group, SIGNON_SVR, until it receives an INIT message specifically for itself.

3. A PPHP relay agent joins SIGNON_SVR group and receives all of the SIGNON messages from the same subnet or segment.

4. After receiving a SIGNON message from the SIGNON_SVR multicasting group, the PPHP relay agent relays the message to a PPHP server using point-to-point TCP message.

5. A PPHP server joins SIGNON_SVR multicasting group and also listens to all of the ports connected to PPHP relay agents.

6. After receiving a SIGNON message from the SINGON_SVR multicasting group, the PPHP server builds up an INIT message using the information from CIDB and the SIGNON message for the client. Then it sends out the INIT message to the multicasting group, INIT_GROUP.

7. After receiving a SIGNON message from a port of a connected PPHP relay agent, the PPHP server builds up an INIT message using the information from CIDB and the SIGNON message for the client. Then it sends out the INIT message to the PPHP relay agent by using a point-to-point TCP communication.

8. After receiving an INIT message from the PPHP server, the PPHP relay agent sends out the INIT message to multicasting group, INIT_GROUP, using multicasting communication.

9. After receiving the matching INIT message on INIT_GROUP, a PPHP client processes the message by configuring the local system using the information from the INIT message.

10. After the configuration, the PPHP client sends out an INIT_DONE message to the PPHP server with a point-to-point TCP message.

Because a centralized ACS may need to manage several hundreds or even thousands of ACCs, thread management is a critical issue in the implementation of the system. The present invention creates an efficient thread management method as described below. A thread manager is implemented to create and manage all of other work threads directly or indirectly. There are two categories of working threads in the system: constant threads and temporary threads. A constant thread is the one that always exists whenever the system is up running. A temporary thread may only exist for a short period of time to conduct a short-term task. All of constant threads are managed directly by the thread manager. Every constant thread needs to send still-alive message periodically to the thread manager. There are two types of constant threads in the system: recoverable and non-recoverable. A recoverable thread is a thread that does not depend on other working threads. Therefore the thread manager can restart a recoverable thread individually at runtime if necessary. A non-recoverable thread is the one that cannot be restarted individually. Therefore the thread manager has to restart the whole system to recover from a failed non-recoverable thread. If one of the managed thread runs into a problem and stops sending the still-alive messages, the thread manager will check the thread type first. If it is a recoverable thread, the thread manager will restart the thread to fix the problem. If it is a non-recoverable thread, the thread manager will restart the PPHP Server as a whole.

To handle short-term tasks for a large number of client computers in a random mode, such as processing SIGNON messages, a growable thread pool is created in the system. While the number of pending tasks is low, the pool maintains a minimum number of threads. While the number of simultaneous tasks increases, the number of threads in the pool grows too up to a limit to handle the spontaneous tasks. For example, whenever a PPHP Server receives a SIGNON message, it dispatches a thread from the pool to process the SIGNON message. After finishing the task, the thread will return to the pool for next pending task. If the number of pending tasks excesses the number of available threads in the pool, the pool will automatically increase the number of threads up to a predefined limit to handle the spontaneous tasks. While the number of pending tasks becomes low, the pool will automatically decrease the number of the threads in the pool to effectively conserve the system resources.

Other embodiments, combinations and modifications of this invention will occur readily to those of ordinary skill in the art in view of these teachings. Therefore, this invention is to be limited only to the following claims, which include all such embodiments and modifications when viewed in conjunction with the above description and accompanying drawings.

I claim:

1. A system for automatic configuration of broadband customer devices, comprising of: an auto configuration server (ACS); a plurality of Subnet Relay Agents (SRA); and a plurality of auto configuration clients (ACC).

2. A method for automatic configuration of broadband customer devices, comprising the steps of:
Receiving requests from the broadband customer devices for auto configuration;
Receiving client identification information with each of the requests, wherein the client identification information includes the MAC address and the alias, such as a room number or phone number, associated with the broadband customer device;
Using the received client identification information and a predefined client information database (CIDB) to determine a computer name for the customer device;
Using the received client identification information and CIDB to build a configuration package for each managed client and send the configuration package to the corresponding ACC;
Receiving and processing the configuration package from acs to configure the broadband device for network communication.

3. The method of claim 2, wherein the computer name determined based on a client identification information and a predefined CIDB is a human-friendly name and is used as the unique ID for the customer device in the system.

4. The method of claim 3, wherein the unique computer name for each managed customer device is obtained through one of the three schemes:
Automatically assigning a unique name to a new client from a pool of predefined unique computer names;
Combining a predefined root name and a client's feature ID, such as a room number, to form a unique computer name for a client;
Providing a name by a client that matches one of the unique names predefined in the CIDB.

5. The method of claim 2, wherein sending and receiving auto configuration requests using a predefined multi-cast group.

6. The method of claim 2, wherein sending and receiving auto configuration packages using a predefined multi-cast group.

7. The method of claim 2, wherein the autoconfiguration attempt is conducted repeatedly until all of the managed clients are successfully configured.

8. The client information database (CIDB) of claim 2 is a central depository of all of client related information, which can be processed in real time.

9. The system of claim 1, wherein each PPHP Relay Agent (SRA) establishes a direct TCP connection with an ACS and relays all of multi-cast communications between the ACS and ACCs in its own subnet.

10. The system of claim 1, wherein the connections among ACS, SRAs and ACCs are used for the further configuration and management of the broadband customer devices.

11. The system claim 1, wherein the combination of a thread manager and a thread pool is used to provide reliable thread management and the ability to handle spontaneous tasks in an ACS.
